(19) United States
(12) Patent Application Publication
(10) Pub. No.: US 2026/0254304 A1
(43) Pub. Date: Aug. 27, 2026

(54) ASYMMETRIC WIRE INSULATION FOR TRACTION MOTOR STATORS

(71) Applicant: FORD GLOBAL TECHNOLOGIES, LLC, Dearborn, MI (US)

(72) Inventors: Akash Changarankumarath PRADEEPKUMAR, Westland, MI (US); Singar RATHNAM, Farmington Hills, MI (US); Jackson David LENZ, Southfield, MI (US)

(21) Appl. No.: 19/060,250

(22) Filed: Feb. 21, 2025

(51) Int. Cl. H02K 3/40; H02K 3/30; H02K 3/34; H02K 15/108

(52) U.S. Cl. CPC H02K 3/40; H02K 3/30; H02K 3/345; H02K 15/108

(57) ABSTRACT

A stator assembly is presented. The stator assembly includes a stator core defining slots and magnetic wires positioned within the slots. Each magnetic wire includes an electrically conductive core and an insulation layer surrounding the core. The insulation layer may have a varying thicknesses, with thinner portions spanning certain sides of the wires and thicker portions spanning other sides.

### TECHNICAL FIELD

This disclosure relates to stator wire configurations for use in electric vehicle motors.

### BACKGROUND

Magnet wire is a component in electric vehicle motors, enabling the generation of magnetic fields that drive the motor. The performance of an electric vehicle motor may depend on the wire's conductivity, insulation, and durability. Adjusting for these properties reduces energy losses and increases thermal management.

### SUMMARY

A stator assembly is provided. This stator assembly includes a stator core defining a plurality of slots and a plurality of magnetic wires positioned within the slots. Each magnetic wire includes an electrically conductive core surrounded by an insulation layer, wherein portions of the insulation layer spanning certain sides of the magnetic wires are thinner than those spanning other sides. The thinner portions of the insulation layer may be adjacent to the stator core, while the thicker portions may be adjacent to other magnetic wires. The insulation layer's asymmetric thickness allows for increased copper area while maintaining the overall dimensions of the magnetic wires, thereby increasing the electrically conductive core fill factor within the stator core's slots. The insulation layer may be made of a polymeric material, such as polyimide, polyesterimide, or polyamideimide. Additionally, the magnetic wires may have a rectangular cross-sectional shape.

A traction motor is provided. This traction motor includes a rotor, a stator with a stator core defining slots, and a plurality of magnetic wires arranged in the slots to form stator windings. Each magnetic wire includes an electrically conductive core and an insulation layer with an asymmetrically distributed thickness. The insulation layer may include a first region with increased thickness for phase-to-phase voltage insulation, capable of withstanding root mean square voltage effects of 1280V, and a second region with reduced thickness for phase-to-core voltage insulation, capable of withstanding root mean square voltage effects of 950V. The magnetic wires may have reduced external dimensions while maintaining the cross-sectional area of the electrically conductive core. The insulation layer may include regions with a thickness of 40 microns, and the magnetic wires may have a rectangular cross-sectional shape.

A method of manufacturing a stator assembly is provided. This method includes wrapping a plurality of wires within slots of a stator such that insulation covering the sides of the wires facing a core of the stator is thinner than insulation covering the sides of the wires facing adjacent wires within the slots of the stator. The method may further include applying asymmetric insulation layers to conductive cores of the plurality of wires prior to wrapping the wires within the slots of the stator. The application of asymmetric insulation layers may include increasing the insulation thickness on sides of the conductive cores requiring phase-to-phase voltage insulation and reducing the insulation thickness on sides requiring phase-to-core voltage insulation. The reduced insulation thickness in low-voltage regions may be controlled to measure between 30 and 40 microns. The conductive cores may be extruded with a rectangular cross-sectional shape to maximize copper fill within the slots of the stator core. The stator assembly may include asymmetric insulation layers made of a polymeric material. The polymeric material may be polyimide, polyesterimide, or polyamideimide.

### BRIEF DESCRIPTION OF THE DRAWINGS

FIGS. 1A-1C are plan views, in cross-section, of magnetic wires for use in stator assemblies;

FIG. 2A is a plan view of a stator core.

FIG. 2B is a plan view, in cross-section, of a slot of the stator core of FIG. 2A wound with magnetic wire; and

FIG. 3 is a flowchart of a method for manufacturing a stator assembly.

### DETAILED DESCRIPTION

In accordance with this disclosure, detailed embodiments of a stator assembly, traction motor, and related manufacturing methods are provided. These embodiments illustrate configurations of magnetic wires with asymmetric insulation layers and their integration into stator windings for traction motors. The figures and descriptions included are illustrative and may not depict every possible variation or configuration of the assembly or methods. Certain features may be emphasized or simplified to highlight aspects of the magnetic wire designs, insulation layer distributions, and associated manufacturing processes. Therefore, the specific structural and operational details described are not intended to limit scope but to serve as a guide for those skilled in the art to implement various embodiments.

Unless otherwise explicitly specified, all numerical values and ranges relating to quantities, measurements, percentages, weights, and similar numerical references within this document are to be understood as being preceded by the term “about.” This applies even in cases where the term “about” is not explicitly used. It is intended that all values and ranges encompass variations that may arise from standard measurement tolerances, manufacturing processes, material properties, and the intended functionality of the disclosed aspects. For example, a stated dimension of “40 microns” should be interpreted as “about 40 microns.” Similarly, when a composition is described as having “5 wt. % of a component,” it is to be understood as “about 5 wt. % of a component.” Furthermore, when numerical values are presented as a range, such as “30 to 40 microns,” this range should be interpreted to effectively mean “about 30 to about 40 microns.” Such variations are implicitly incorporated within the scope of the present disclosure.

The present disclosure relates to an asymmetric wire insulation design for magnet wire used in traction motor stators, particularly in electric vehicles. Magnet wire is a component in these motors, enabling the generation of magnetic fields required for operation. The performance of magnet wire, including its electrical conductivity, insulation properties, and durability, directly influences the motor's efficiency, reliability, and power output.

Magnet wires include a conductive core, such as copper or aluminum, surrounded by an insulating layer. Copper may be a preferred material for the conductive core due to its electrical conductivity, low resistive losses, and mechanical strength. These properties are sometimes necessary for minimizing energy losses, reducing heat generation, and ensuring structural integrity under high-speed and high-vibration conditions typical in electrical vehicle traction motors. Aluminum, while lighter, has a lower conductivity and may be used in applications where weight reduction outweighs the need for higher performance.

The insulation surrounding the conductive core serves to electrically isolate it from neighboring wires and the grounded stator core. This insulation may be made from polymeric materials with high dielectric strength, thermal stability, and mechanical resilience. Suitable materials include polyimide, polyesterimide, and polyamideimide. In high-performance motors, the insulation may be a multilayer system to provide additional protection against thermal aging and mechanical effects.

One of the considerations when designing magnet wire insulation is its ability to withstand partial discharge, which occurs when localized electrical discharges partially bridge the insulation under high voltage effects. Over time, partial discharge affects the insulation. Therefore, the insulation should meet partial discharge inception voltage (PDIV) requirements. These requirements may be influenced by the voltage effects experienced in different regions of the motor.

Traction motors experience phase-to-phase and phase-to-core voltage effects. Phase-to-phase voltage effects occur between adjacent conductors carrying different phases of current and typically involve the highest voltage differentials. In contrast, phase-to-core voltage effects occur between the conductor and the grounded stator core and may be generally lower.

In an example 800 volt (V) traction motor phase-to-phase terminal voltage may be calculated by:

phase-to-phase terminal voltage=TV×SF_{PD}×SF_{Thermal}
Where:
TV=Terminal Voltage
SF_{PD}=Factor for Partial Discharge
SF_{Thermal}=Thermal Factor

### Substituting Values:

phase-to-phase terminal voltage=1200×1.25×1.2=1800V

$$phase - to - phase terminal voltage root means square ( rms ) = \frac{1800}{√ 2} = 1280 {V}_{rms}$$

In the same example 800V traction motor phase-to-core RMS may be calculated by:

$$phase - to - core RMS = \frac{TV}{\sqrt{2}} \times {SF}_{PD} \times {SF}_{Thermal}$$

$$phase - to - core RMS = \frac{1200}{\sqrt{2}} \times 1.25 \times 1.25 = 950 V rms$$

Based on the equations the phase-to-phase RMS voltage may reach approximately 1280V, whereas the phase-to-core RMS voltage is closer to 950V. These differences in voltage effects allow for an insulation design that varies the insulation thickness according to the specific requirements of each region.

The present disclosure introduces an asymmetric insulation design that applies thicker insulation to regions with higher electrical insulation requirements, such as phase-to-phase regions, and thinner insulation to regions with lower requirements, such as phase-to-core regions. This may be achieved through an insulation extrusion process, allowing for controlled application of insulation thickness. For example, in a magnet wire design, the insulation thickness may be uniformly 170 microns on all sides of the wire. However, in the proposed asymmetric design, the thickness in low-voltage regions may be reduced to as little as 40 microns while maintaining the necessary electrical insulation properties.

With the PDIV targets established, the insulation system for the motor, including both the magnet wire and the slot liner thickness, can be designed using the following equation:

$$V = 163 \times {( \frac{t}{{∈}_{{r}_{W V}}} )}^{0.46}$$

The composite relative permittivity of the enamel and varnish system (Erwy) may be calculated by:

$${∈}_{{r}_{WV}} = \frac{{∈}_{Enamel} \times {∈}_{Varnish} \times ( 2 \times {t}_{enamel} + {Gap}_{BetweenPhases} )}{{∈}_{enamel} \times {Gap}_{BetweenPhases} + 2 \times {t}_{enamel} \times {∈}_{Varnish}}$$

$${∈}_{{r}_{WV}} = \frac{3.06 \times 3.9 \times ( 2 \times 0.17 + 0.25 )}{3.06 \times 0.25 + 2 \times 0.17 \times 3.9} = 3.367 = 3.37 approx .$$

Where:
∈_{Enamel} is relative permittivuty of enamel
∈ᵥₐᵣₙᵢₛₕ is relative permittivity of varnish
∈_{rWV} is composite relative permitivity of enamel and varnish
tₑₙₐₘₑₗ is enamel coating thickness

An additional factor of 1.33 accounts for the winding process and handling. The enamel thickness is designed to address two primary scenarios: phase-to-phase PDIV and phase-to-core PDIV. To address Phase to phase PDIV, the following equation is used:

$$S {F}_{Additonal} \times Phase to Phase {PDIV}_{r m s} = 163 \times {( \frac{1000 \times ( 2 \times {t}_{enamel} + {Gap}_{BetweenPhases} )}{{∈}_{{r}_{Wire / Varnish}}} )}^{0.46}$$

### By Substitution:

$$1.33 \times 1280 = 163 \times {( \frac{1000 \times ( 2 \times {t}_{enamel} + 0.25 )}{3.37} )}^{0.46}$$

$${t}_{enamel} = \frac{{( \frac{1.33 \times 1280}{1.63} )}^{\frac{1}{0.46}} \times ( \frac{3.37}{1000} ) - 0.25}{2} = 0.15 mm approx .$$

To address phase-to-core PDIV for a given slot liner thickness of 0.175 mm, we have the following equation:

$$phase - to - core {PDIV}_{r m s} = 163 \times {( \frac{1000 \times ( {t}_{enamel} + {t}_{Slot Liner} )}{{∈}_{{r}_{SL / MW}}} )}^{0.46}$$

$$950 / 0.8 = 163 \times {( \frac{1000 \times ( {t}_{enamel} + 0.175 )}{3.86} )}^{0.46}$$

$${t}_{e n a m e l} = {( \frac{950}{163} )}^{\frac{1}{0.46}} \times ( \frac{3.86}{1000} ) - 0.175 = 0.003 mm$$

This means that the insulation utilized may be only 3 microns thick across the magnet wire wall. Reducing insulation thickness in low-voltage regions allows for an increase in the copper fill factor within the stator slots. By decreasing the space occupied by insulation, more copper may be packed into the slots, resulting in a 7-10% increase in copper cross-sectional area for a given slot dimension as shown by the equation below:

$$Total increase in copper inslot fill = ( \frac{3.28 \times 1.704 - ( 3.28 + 2 \times ( 0.15 - 0.04 ) ) \times 1.704}{3.28 \times 1.704} )$$

This increased copper fill directly translates to higher current-carrying capacity, enabling greater torque and power output. A 1% increase in copper fill typically corresponds to an approximately 1% increase in motor torque and power output, though the exact improvement depends on the motor's design and operating conditions.

The asymmetric insulation design exhibits increased thermal performance. The thinner insulation in low-voltage regions reduces thermal resistance, facilitating heat dissipation from the copper conductors to the stator core and end windings. Increased thermal conductivity lowers the motor's operating temperature, reducing cooling requirements and increasing overall efficiency. Additionally, reducing winding resistance by increasing the copper cross-sectional area minimizes copper losses, further enhancing efficiency and extending the vehicle's range.

By using less insulation material, the overall manufacturing complexity of the magnet wire is reduced. Furthermore, the improved motor efficiency and power output enabled by the increased copper fill may lead to system-level operational simplifications. For example, a motor with higher efficiency may require a smaller battery or a less extensive cooling system.

From a reliability standpoint, the asymmetric insulation design minimizes thermal and electrical effects on the motor components, reducing the likelihood of insulation issues and other performance issues.

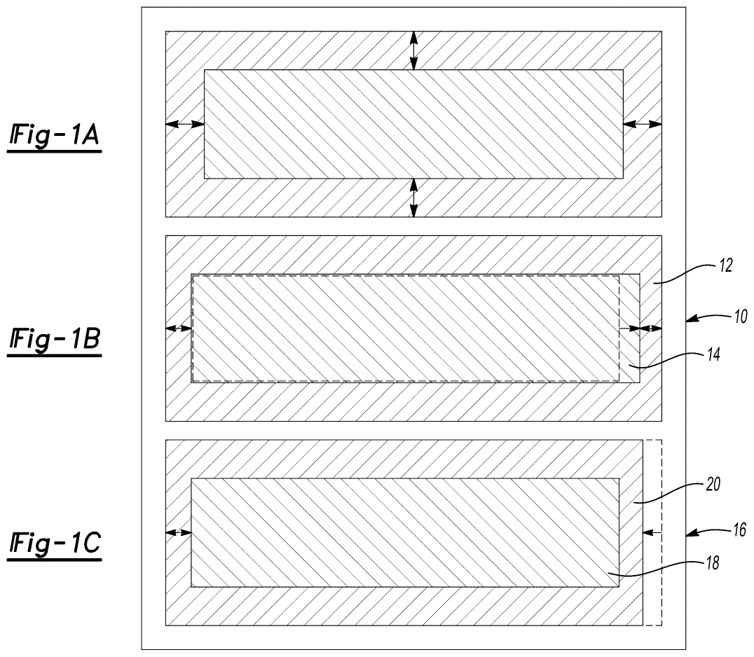

FIGS. 1A-1C are cross-sectional diagrams of magnetic wires suitable for use in stator assemblies. FIG. 1A shows a baseline of current configurations, where a magnetic wire includes an electrically conductive core surrounded by an insulation layer of uniform thickness on all sides. This symmetrical wire cross-section maintains consistent phase-to-phase and phase-to-core voltage insulation and maintains the overall wire dimensions, as is typical in conventional designs. However, this configuration does not adjust the conductive core area or the fill factor within the stator core slots.

FIG. 1B shows a first concept for a magnetic wire 10, which modifies an insulation layer 12 to increase the area of an electrically conductive core 14 while maintaining the overall dimensions of the magnetic wire 10. In this configuration, the insulation layer thickness on the sidewalls that will face the stator core are reduced, allowing a material of the electrically conductive core 14 to expand circumferentially. This increases the material fill factor within stator core slots, thereby increasing the current-carrying capacity without altering the external dimensions of the magnetic wire 10. The reduced thickness of the insulation layer 12 on these sidewalls allows for increased conductive performance while maintaining adequate insulation for phase-to-phase and voltage insulation.

FIG. 1C shows a second concept for a magnetic wire 16, which reduces the overall size of the magnetic wire 16 while maintaining the cross-sectional area of an electrically conductive core 18. In this design, an insulation layer 20 is uniformly thinned on all sides, resulting in a smaller external size of the magnetic wire 16. This configuration is advantageous for applications requiring compact stator windings, as it allows for increased space efficiency within stator core slots while preserving area of the electrically conductive core 18 to maintain electrical conductivity of the magnetic wire 16. The reduced thickness of the insulation layer 20 is configured to provide sufficient insulation for phase-to-phase and phase-to-core voltages, with specific regions potentially having thicknesses optimized for RMS voltage requirements.

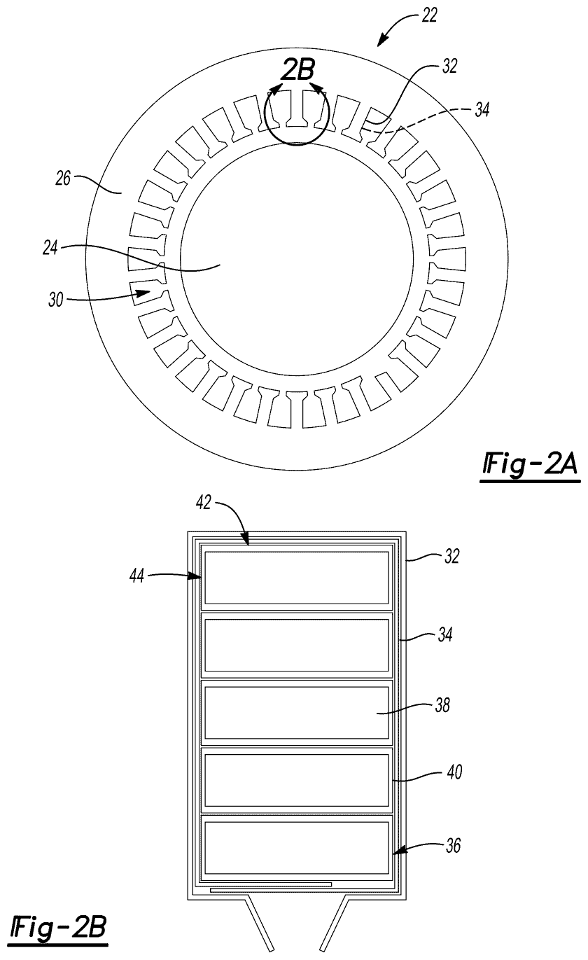

FIGS. 2A and 2B show a traction motor and configuration of magnetic wires used in a stator assembly. FIG. 2A shows a traction motor 22 with a rotor 24 and a stator 26. The stator 26 defines a plurality of slots 30, which are configured to accommodate stator windings formed by a plurality of magnetic wires 36. FIG. 2B shows a magnified cross-sectional view of windings in the slot 30. Each magnetic wire 36 includes an electrically conductive core 38 surrounded by an asymmetric insulation layer 40, with portions of the asymmetric insulation layer 40 asymmetrically distributed to increase performance of the traction motor 22.

The slot 30 is defined by a stator core wall 32 and is lined with a slot liner 34 to electrically insulate the magnetic wires 36 from the stator core wall 32. Each magnetic wire 36 includes the electrically conductive core 38 and the asymmetric insulation layer 40 that surrounds the electrically conductive core 38. The asymmetric insulation layer 40 is distributed asymmetrically, with portions of reduced thickness on the sides adjacent to the stator core wall 32 and portions of increased thickness on the sides adjacent to the other magnetic wires 36. This configuration allows for an increased fill factor of the electrically conductive cores 38 within the slot 30 while maintaining the overall dimensions of the magnetic wire 36 and providing sufficient insulation for phase-to-phase and phase-to-core voltage requirements.

The asymmetric insulation layer 40 includes a first region 42 of increased thickness to provide increased insulation for phase-to-phase voltage insulation, configured to withstand root mean square voltage effects of, in this example, 1280V. A second region 44 of reduced thickness is configured for phase-to-core voltage insulation, capable of withstanding root mean square voltage effects of, in this example, 950V. In one embodiment, the thickness of the asymmetric insulation layer 40 in the reduced region 44 is approximately 40 microns, enabling compact and efficient use of space within the slots 30. This configuration increases the conductive material fill factor, increasing the current-carrying capacity of the magnetic wires 36 without reducing the cross-sectional area of the electrically conductive cores 38.

The asymmetric insulation layer 40 may be made of a polymeric material such as polyimide, polyesterimide, or polyamideimide, which provides high durability and electrical insulation properties. The magnetic wires 36 may have a rectangular cross-sectional shape, allowing for further optimization of the slot fill factor.

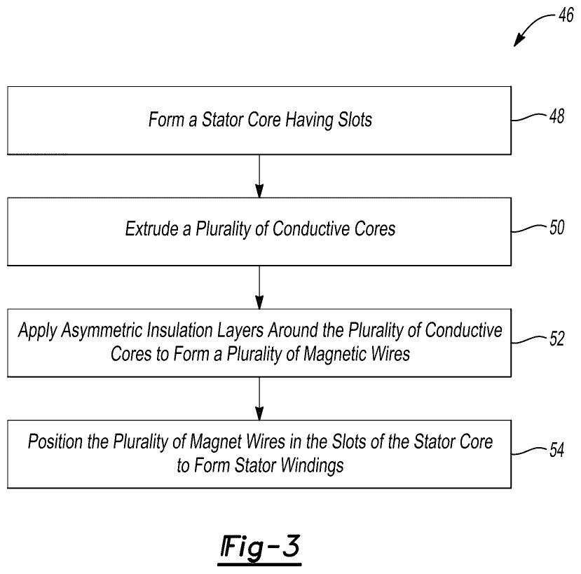

FIG. 3 is a flowchart showing a method 46 for manufacturing a stator assembly. The method 46 begins at step 48 with the formation of a stator core having a plurality of slots. The stator core is configured to accommodate stator windings, with the slots providing designated areas for the placement of magnetic wires.

At step 50, a plurality of conductive cores is extruded. These conductive cores form the electrically conductive elements of the magnetic wires and are shaped to achieve a desired cross-sectional geometry, such as a rectangular shape, to maximize the conductive core fill factor within the stator core slots.

At step 52, asymmetric insulation layers are applied around the plurality of conductive cores to form a plurality of magnetic wires. The insulation layer is applied with an asymmetric thickness to provide enhanced electrical insulation properties. Thicker regions of the insulation layer are configured to withstand higher phase-to-phase voltages, while thinner regions are designed for phase-to-core voltage insulation, optimizing the fill factor of the magnetic wires within the stator core slots without reducing the conductive core area. This step may involve techniques such as coating or extrusion to achieve the desired insulation layer configuration.

At step 54, the plurality of magnetic wires is positioned in the slots of the stator core to form stator windings. The magnetic wires are aligned and secured within the slots to establish the electrical pathways necessary for the generation of electromagnetic forces in the stator assembly.

The embodiments described above are specific examples that do not describe all possible forms of the disclosure. The features of the illustrated embodiments may be combined to form further embodiments of the disclosed concepts. The words used in the specification are words of description rather than limitation. The scope of the following claims is broader than the specifically disclosed embodiments and also includes modifications of the illustrated embodiments.

What is claimed is:

1. A stator assembly comprising:
a stator core defining a plurality of slots; and
a plurality of magnetic wires in the slots, each of the magnetic wires having sides, an electrically conductive core, and an insulation layer surrounding the electrically conductive core, wherein portions of the insulation layer spanning some of the sides are thinner than portions of the insulation layer spanning other of the sides.

2. The stator assembly of claim 1 wherein the portions of the insulation layer spanning some of the sides face the stator core.

3. The stator assembly of claim 1 wherein the portions of the insulation layer spanning the other of the sides face other of the magnetic wires.

4. The stator assembly of claim 1 wherein the insulation layer is made of a polymeric material.

5. The stator assembly of claim 4 wherein the polymeric material is polyimide, polyesterimide, or polyamideimide.

6. The stator assembly of claim 1 wherein the magnetic wires have a rectangular cross-sectional shape.

7. A traction motor comprising:
a rotor;
a stator core surrounding the rotor and defining a plurality of slots; and
a plurality of wires arranged in the slots to form stator windings, each of the wires including an electrically conductive core and an insulation layer having a thickness that is asymmetrically distributed around the electrically conductive core.

8. The traction motor of claim 7 wherein each of the wires includes a first region of the insulation layer with increased thickness for phase-to-phase voltage insulation.

9. The traction motor of claim 8 wherein each of the wires includes a second region of the insulation layer with reduced thickness for phase-to-core voltage insulation.

10. The traction motor of claim 8 wherein the first region of the insulation layer is configured to withstand phase-to-phase root mean square voltage effects of 1280V.

11. The traction motor of claim 9 wherein the second region of the insulation layer is configured to withstand phase-to-core root mean square voltage effects of 950V.

12. The traction motor of claim 7 wherein the insulation layer of each of the wires includes a region with a thickness of 40 microns.

13. The traction motor of claim 7 wherein each of the wires has a rectangular cross-sectional shape.

14. A method of manufacturing a stator assembly comprising:
wrapping a plurality of wires within slots of a stator such that insulation covering sides of the wires facing a core of the stator is thinner than insulation covering sides of the wires facing adjacent wires within the slots of the stator.

15. The method of claim 14, further comprising applying asymmetric insulation layers to conductive cores of the plurality of wires prior to the wrapping.

16. The method of claim 15 wherein the applying includes increasing insulation thickness on the sides of the conductive cores requiring phase-to-phase voltage insulation and reducing insulation thickness on the sides requiring phase-to-core voltage insulation.

17. The method of claim 16 wherein the asymmetric insulation layers have a thickness of 30-40 microns on the sides requiring phase-to-core voltage insulation.

18. The method of claim 15 wherein the conductive cores are extruded with a rectangular cross-sectional shape to maximize copper fill within the slots.

19. The stator assembly of claim 15 wherein the asymmetric insulation layers are made of a polymeric material.

20. The stator assembly of claim 19 wherein the polymeric material is polyimide, polyesterimide, or polyamideimide.
